(19) United States
(12) Patent Application Publication
(10) Pub. No.: US 2001/0032258 A1
(43) Pub. Date: Oct. 18, 2001

(54) System for internet connections, system for providing internet user information, method for providing internet user preference information, and method for distributing digital contents using the internet

(75) Inventors: Atsuki Ishida, Kanagawa (JP); Takafumi Kusano, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Kabushiki Kaisha Free Bit.com

(21) Appl. No.: 09/735,222

(22) Filed: Dec. 11, 2000

(30) Foreign Application Priority Data
Mar. 31, 2000 (JP) 2000-099362
Jun. 19, 2000 (JP) 2000-182692

(51) Int. Cl. G06F 15/173; G06F 15/16

(52) U.S. Cl. 709/224; 709/245; 709/218

(57) ABSTRACT

A system for Internet connections, which connects a user terminal to the network. The system comprises: a terminal server for assigning a predetermined IP address to the user terminal and connecting this user terminal to a request Web site through an Internet network; a certification server for outputting IP address usage information of the user as well as performing a certification for the user who accesses the terminal server; a substitute server, through which the Internet connection is routed when the user terminal is connected to the request Web site in order to record/output an access log for the Web site accessed by the IP address; and an update server for referencing the access log, recorded/output by the substitute server, and the IP address usage information, output by the certification server, to thereby output the Web site in association with the user who accesses this Web site.

### BACKGROUND OF THE INVENTION

1. Field of the Invention

The present invention relates to a system for Internet connections, a system for providing Internet user information, a method for providing Internet user preference information and a method for distributing digital contents using the Internet, which enable to collect preference information of Internet users when the Internet users are connected to the Internet based on an Internet connection log of each user.

2. Description of the Prior Art

Recently, as the number of Internet users has been rapidly increasing, various techniques for providing online information using the Internet have been attracting the public attention. It is required that such techniques promptly offer contents which suit preferences of each user.

For this reason, such techniques have been employing methods for, for example, requesting each user to enter information including user attributes and user preferences in a questionnaire when a user registers himself/herself for various information services, and providing the user with advertisements, information and the like which match the user preferences according to the above information.

However, preference information obtained with the techniques described above are “static”: Once entered, the preference information is never or seldom updated since updates are performed by the user only voluntarily.

The user preferences are, by nature, dynamic information affected by the user's interests, concerns and the like, which change on a day-to-day basis. Therefore, there is a general concern that the preference information obtained with the above methods will become obsolete over time and that the user will start to receive contents which do not match his/her needs as a result.

### SUMMARY OF THE INVENTION

An object of the present invention, created in consideration of the above circumstances, is to provide a system for Internet connections and the like, which are installed at an Internet service provider and capable of obtaining up-to-date user preference information without having to request information entry by a user.

In order to achieve the above objective, according to the first primary aspect of the present invention, there is provided a system for Internet connections, which connects a user to a network, comprising: an IP address usage information storage means for storing usage information regarding an IP address in association with the user using the IP address; an access log recording means for recording an access log for a Web site in association with a IP address; and an access information output means for referencing the usage information regarding the IP address and the access log for the Web site, to thereby associate and output an address of the Web site and information of the user who accesses this Web site.

According to such a structure, it is possible to obtain Web site access information of the user by performing IP address matching based on information of an IP address usage by the user and log information of a Web site (URL) access by the IP address.

According to one embodiment of the present invention, the system for Internet connections further comprises: means for storing and identifying information on user permission to output access information, wherein the aforesaid access information output means outputs the access information if the user permits an output of the access information. In this case, it is preferable that there are further comprised means for providing access information and collective user information for users who permit an output of the aforesaid access information.

According to such a structure, access information of the user can be output to an external system based on the user decision. Also, it is possible to obtain the collective user information of the users who permit an output of the access information to thereby maintain a reliable information source.

According to one embodiment of the present invention, this system for Internet connections further comprises: a certification means for performing user certification, wherein the aforesaid IP address usage information storage means associates and stores user information obtained by this certification means and the IP address usage information.

According to such a structure, it is possible to identify the user based on a certification operation at the time of the user access and obtain the IP address usage information for this user.

According to one embodiment of the present invention, this system for Internet connections further comprises: means for categorizing and storing information on various Web sites; and means for referencing the aforesaid access information from the aforesaid access information output means and category information to thereby associate and output a category of a Web site accessed and information of the user who accesses this Web site.

Here, it is preferable that this system comprises: means for accumulating usage category information of the user to thereby analyze the user preferences; and means for outputting preference information in association with the user ID.

Also, it is desirable that this system for Internet connections comprises: a content storage means for storing various contents in association with the category; and means for extracting contents from the aforesaid content storage means and distributing the contents to the user based on the preference information of the user.

According to such a structure, it is possible to ensure distribution of contents suitable for the user preferences, which change dynamically. Also, it is possible to distribute effective advertisements using, for example, digital contents.

Also, according to the second aspect of the present invention, there is provided a system for providing Internet user information, comprising: means for storing the user information in association with Web site access information of the user; means for categorizing and storing information on various Web sites; and means for referencing the aforesaid access information and the category information to thereby associate and output the category of the Web site accessed and information of the user who accesses this Web site.

In this case, there is preferably comprised: means for accumulating usage category information of the user to thereby analyze the user preferences; and means for outputting the preference information in association with the user ID.

Also, this system for providing Internet user information preferably comprises: a content storage means for storing various contents in association with the category; and means for extracting contents from the aforesaid content storage means and distributing the contents to the user based on the preference information of the user.

According to such a system, it is possible to analyze the user preferences based on Web site access information for each user, which is received from an external system, and ensure distribution of digital contents suitable for the user preferences, which change dynamically.

Also, according to the third aspect of the present invention, there is provided a system for Internet connections, comprising: an IP address usage information storage means for storing usage information regarding an IP address in association with a user ID using the IP address; a content storage means for storing contents corresponding to the user preferences in association with the user ID; and means for extracting contents corresponding to the user preferences from the aforesaid content storage means and displaying the contents on the user terminal using the IP address.

According to such a structure, it is possible to display digital contents suited to preferences of this user on the user terminal when the user is connected to the Internet.

Also, according to the third aspect of the present invention, there is provided a method for providing Internet user preference information, wherein an Internet service provider obtains a Web site access log for a user of the Internet connection service; and the Internet service provider system generates and provides preference information of the user based on this Web site access log.

Furthermore, according to the fourth aspect of the present invention, there is provided a method for distributing digital contents using the Internet, comprising the steps of: receiving Web site access information of a user of the Internet connection service from the Internet service provider to thereby generate preference information of the user; and distributing digital contents corresponding to the preference information to the user.

Also, according to the fifth primary aspect of the present invention, there is provided a system for Internet connections, which connects a user terminal to the network, comprising: means for obtaining user signal source geographical region information; a content generation means for generating contents according to a signal source geographical region; and a content distribution means for distributing the contents generated by the aforesaid content generation means to the user terminal connected to the Internet.

According to such a structure, it is possible to distribute to the user contents related to the signal source geographical region. Thus, the user can receive contents which he/she desires the most during, for example, his/her business trip or vacation without changing his/her own preference information.

According to one embodiment of the present invention, the aforesaid means for obtaining user signal source geographical region information comprises: means for obtaining signal source information of the user, which is included in an incoming signal from a telephone company; and a signal source geographical region determination means for determining the signal source geographical region based on this telephone number if the aforesaid signal source information contains a signal source telephone number. If the signal source information does not include the signal source telephone number of the user, the aforesaid signal source geographical region determination means preferably determines a geometrical region of an access point accessed by the user as the signal source geographical region.

According to such a structure, it is possible to determine the signal source geographical region based on the signal source telephone number if the signal source telephone number is obtainable in the incoming signal from the telephone company, or it is possible to determine the geometrical region where the access point is provided if the signal source telephone number is not obtainable in the incoming signal from the telephone company.

Incidentally, if a collect call telephone number is assigned to the access point, a line connection may be refused based on the fact that the signal source information is not included in the incoming signal from the telephone company. Thus, the Internet service provider can avoid unnecessary charges.

Also, according to another embodiment of the present invention, the aforesaid content distribution means distributes the aforesaid contents to the user by routing a connection of the user to a site which includes the aforesaid contents. According to such a structure, the aforesaid contents can be displayed in real time separately from information of a URL being accessed by the user by utilizing a browser frame function, for example.

According to yet another embodiment of the present invention, this system further comprises: means for storing IP address usage information in association with the user of this IP address; and an access log recording means for recording an access log of a Web site accessed by the user using an IP address used for the Internet connection; wherein the aforesaid content distribution means has means for referencing the IP address in log information, recorded by the access log recording means, and the aforesaid IP address usage information to thereby determine a Web site accessed by the user and distribute contents related to this Web site to the user terminal.

According to such a structure, digital contents according to the user's preferences can be displayed on the user terminal while the user is connected to the Internet.

In this case, the aforesaid access log recording means is preferably provided in a substitute server, through which the user terminal is connected to the Internet. Also, it is desirable that the aforesaid content distribution means has means for storing categorized information on various Web sites, determines a category to which the Web site, accessed by the user, belongs and distributes contents related to the category to the user.

According to the sixth primary aspect of the present invention, there is provided a system for Internet connections, which connects a user terminal to a network, comprising: means for obtaining signal source information of the user from the telephone company; a signal source geographical region determination means for determining the signal source geographical region for the user with this signal source information; and a user signal source geographical information output means for outputting the signal source geographical region, determined by this signal source geographical region determination means, in association with the user.

According to such a structure it is possible to, for example, determine and output the user signal source geographical region associated with the line connection in order to distribute contents according to the signal source geographical region of the user.

Here, the user signal source geographical region output means preferably outputs the user signal source geographical information in response to an output request, from the Web site accessed by the user, for the user signal source geographical information which indicates the IP address of the user.

According to such a structure, the Web site can send an advertisement and the like to the user based on the user signal source geographical region received from this system for Internet connections.

According to the seventh aspect of the present invention, there is provided a system for Internet connections, which connects a user terminal to a network, comprising: means for assigning an IP address to the user terminal and connecting the user terminal to the Internet; means for storing user information in association with the user; and means for outputting the user information to a Web site, which is accessed by the user, in response to an output request from the Web site for the user information which indicates the IP address of the user.

According to such a structure, the Web site can send an advertisement and the like which suits the signal source geographical region, preferences and the like of the user, based on the user information received from this system for Internet connections.

According to the eighth aspect of the present invention, there is provided a system for distributing contents to the user terminal through the Internet, comprising: means for obtaining user signal source geographical region information; a content generation means for generating contents according to the signal source geographical region for the user; and a content distribution means for distributing to the user terminal the contents, generated by the aforesaid content generation means according to the aforesaid signal source geometrical region.

According to such a structure, it is possible to generate contents according to the signal source geographical region for the user and distribute the contents to the user terminal. Thus, the user can receive contents which he/she desires the most, for example, after moving to another geographical region, or during his/her business trip or vacation without changing his/her own preference information.

According to the ninth aspect of the present invention, there is provided a method for providing information to an Internet user, wherein the Internet service provider determines the signal source geographical region for a user of its Internet connection service, generates contents related to this signal source geographical region and provides the contents to the user.

According to such a structure, the user can receive contents which he/she desires the most, for example, after moving to another geographical region, or during his/her business trip or vacation without changing his/her own preference information.

According to the tenth aspect of the present invention, there is provided an Internet connection program product for issuing a command to a computer system to establish a dial-up connection with a predetermined Internet connection access point, comprising: storage media; means stored in this storage media for determining a line network type used; and means stored in the aforesaid storage media for adding a signal source information provision code to the signal source telephone number if a line network type being used is a predetermined line network type.

According to such a structure, it is possible to send signal source information such as the signal source telephone number and the like to the Internet service provider in order to distribute to the user contents according to the signal source geographical region.

Incidentally, other characteristics and marked effects of the present invention will become apparent upon referring to explanations of the following specification when taken in conjunction with the accompanying drawings.

### BRIEF DESCRIPTION OF THE DRAWINGS

FIG. 1 is a function block diagram showing a system for Internet connections according to a first embodiment of the present invention;

FIG. 2 is a diagram showing one example of user information;

FIG. 3A and FIG. 3B are diagrams showing one example of user-IP address usage information;

FIG. 4 is a diagram showing one example of an IP address-URL access log;

FIG. 5 is a diagram showing one example of user-URL access information;

FIG. 6 is a function block diagram showing one example of a system for providing Internet user information;

FIG. 7 is a diagram showing one example of Web site category information;

FIG. 8 is a diagram showing one example of content information;

FIG. 9 is a diagram showing one example of user preference information;

FIG. 10 is a function block diagram showing a system for Internet connections according to another embodiment of the present invention;

FIG. 11 is a diagram showing the user-IP address usage information according to the another embodiment;

FIG. 12 is a schematic structural view showing a system for Internet connections according to a second embodiment of the present invention;

FIG. 13 is a schematic structural view showing an update server according to the second embodiment;

FIG. 14 is a drawing showing one example of access point information according to the second embodiment;

FIG. 15 is a drawing showing one example of IP address usage information according to the second embodiment;

FIG. 16 is a drawing showing one example of a signal source determination algorithm according to the second embodiment;

FIG. 17 is a drawing showing one example of signal source geographical region information according to the second embodiment;

FIG. 18 is a drawing showing one example of IP address usage information according to the second embodiment;

FIG. 19 is a schematic structural view showing a structure of a user terminal in which a program for line connections is installed according to the second embodiment; and

FIG. 20 is a drawing showing one example of an interface of the program for line connections according to the second embodiment.

### DETAILED DESCRIPTION OF THE PREFERRED EMBODIMENT

Embodiments of the present invention will be described below based on the accompanying drawings.

(First Embodiment)

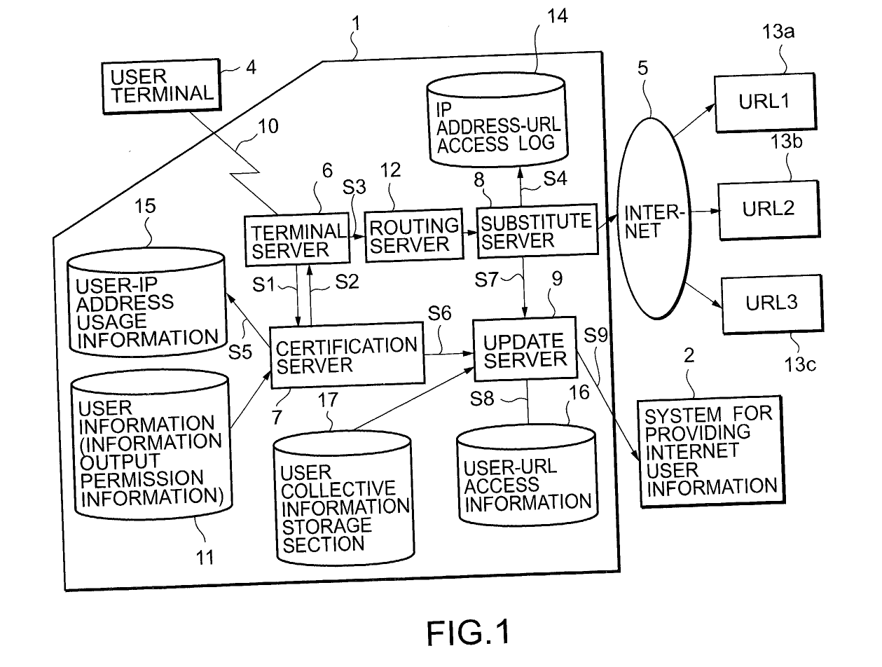

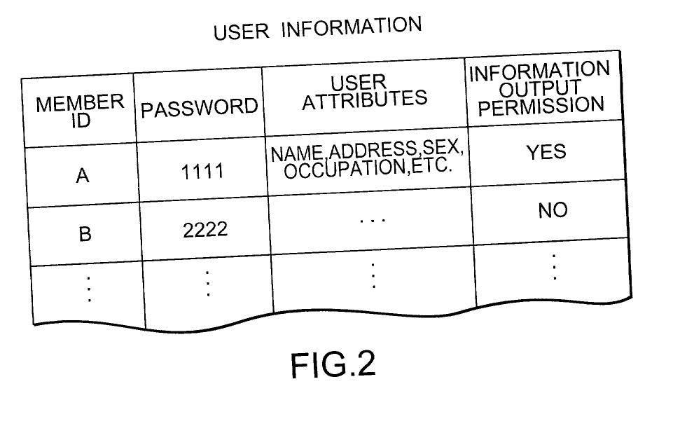

FIG. 1 is a function block diagram showing a system for Internet connections 1 according to the first embodiment of the present invention. FIG. 2 is a function block diagram showing a system for providing Internet user information 2 connected to the system for Internet connections 1. Incidentally, S1-S18 in each drawing is step reference numbers used for explaining processing procedures of the systems 1 and 2, respectively.

First, as shown in FIG. 1, the aforesaid system for Internet connections 1 comprises a terminal server 6, which assigns an IP address to a user 4 (a user terminal), attempting a dial-up connection, and connects the user 4 to Internet 5, a certification server 7, which performs certification of the user 4, who is connected to the aforesaid terminal server 6, and records IP address usage information, a substitute server 8, which is designed to always exist in a connection path between the user 4 and the Internet, and obtains a URL access log of the IP address used for the connection, and an update server 9, which calculates access information of each user 4 from the IP address usage information and the aforesaid URL access log and outputs the access information as update information to an external system (the system for providing Internet user information 2).

In the following, a structure and functions of this system 1 will be described based on its behavior.

First, the aforesaid terminal server 6 has a plurality of ports (not illustrated) to each of which a modem is connected, and is set to connect to the user 4 through, for example, a public circuit 10. Upon receipt of a user ID and a password as certification information from the user 4, this terminal server 6 issues a certification command to the aforesaid certification server 7 (step S1).

As shown in FIG. 2, this certification server 7 is connected to a user information storage section 11, which stores user information including, for example, the user ID and password. Then, this certification server 7 checks the certification information entered by the user 4 with the user information stored in the user information storage section 11 (FIG. 2) to thereby performs certification of the user 4. Then, this certification server 7 returns affirmation or negation as a certification result to the aforesaid terminal server 6 (step S2).

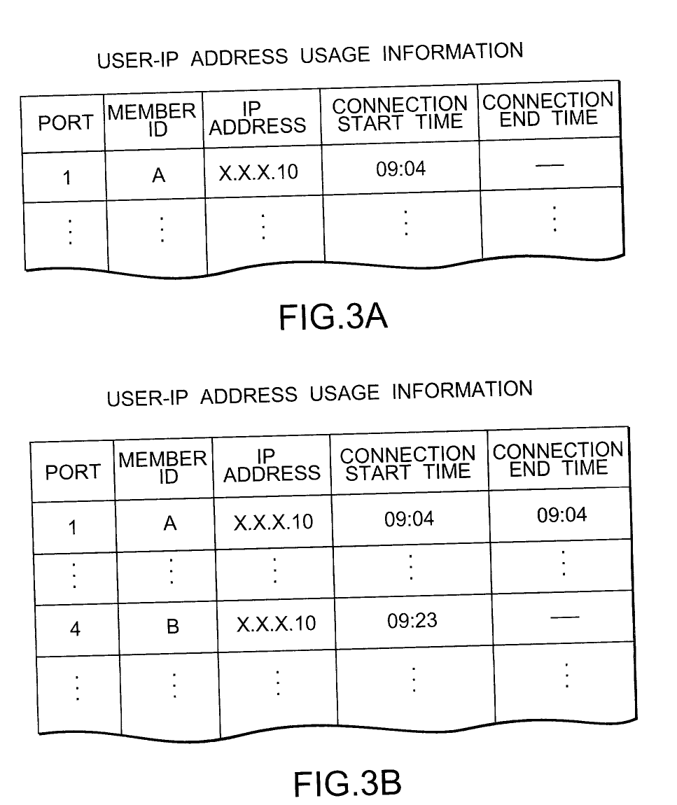

Upon receipt of an affirmative certification result, the terminal server 6 permits an Internet connection for the user 4 and assigns a unique IP address to a port to which the user 4 is connected as shown in FIG. 3A. Thereby, the user 4 can download/upload information by connecting to/accessing various URL's (Web sites) using this IP address until he/she disconnects from the terminal server 6.

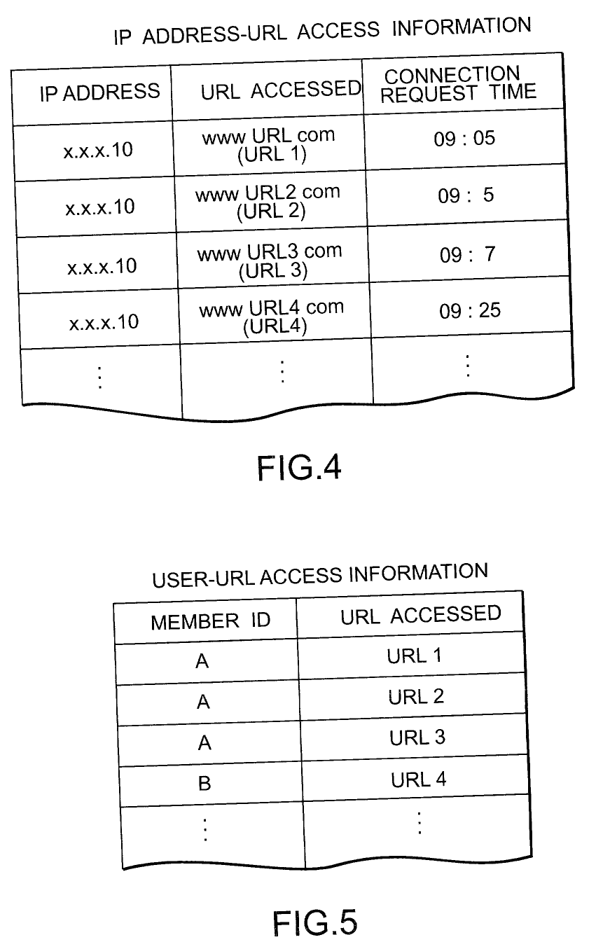

Here, the terminal server 6 is connected to a routing server 12 (router) and this routing server 12 functions so that all Internet connections through the terminal server 6 are routed through the aforesaid substitute server 8. For example, if the user 4 issues a browsing request of a URL 1, shown as 13a in the drawing, the user 4 will be connected to the URL 1 through the aforesaid substitute server 8 (step S3). Thereby, the substitute server 8 obtains a URL access log, which indicates the time of access, the IP address used and the URL to which an access request was issued, and stores URL access log information in an IP address-URL access log storage section 14 (step S4). Then, as shown in FIG. 4, the aforesaid substitute server 8 records additional access log information every time the user 4 issues a connection request to a URL (URL 2, URL 3 and the like).

Next, if the user 4 disconnects from the terminal server 6, the aforesaid certification server 7 stores the IP address usage information, that is, connection start time and connection end time for the IP address, associated with the certification information of the user (user ID) in a user-IP address usage information storage section, indicated with the number 15 in the drawing (step S5). FIG. 3B shows a condition in which a user with a member ID=A completed a disconnection. Then, when the user disconnects, the aforesaid certification server 7 issues an update command to the aforesaid update server 9 (step S6).

Based on this update command, the update server 9 extracts the URL access log for this IP address and the time period this IP address was used from the aforesaid IP address-URL access log storage section 14 through the aforesaid substitute server 8 as shown in FIG. 4 (step S7).

Then, this update server 9 identifies the user (user ID), who issued a connection request for the URL, based on the IP address usage information of the user 4 (FIG. 3B) and the URL access log for this IP address (FIG. 4). Next, the update server 9 outputs and stores information of this URL associated with the user information in a user-URL access information storage section 16. Thereby, URL access information for each of the user 4 will be accumulated in this user-URL access information storage section 16 as shown in FIG. 5 (step S8)

This URL access information for each user 4 will become source data for a user preference analysis. This URL access information is sent to the aforesaid Internet user information system 2 by the update server 9 (step S9) and processed to create user preference information in this user information providing system 2 as described below.

Preferably, an output of the URL access information to this Internet user information system 2 is performed based on a decision by the user 4. Therefore, information output permission (prohibition) information by the user 4 is stored in the user information storage section 11 as shown in FIG. 2, and the aforesaid certification server 7 is structured to issue the update command to the aforesaid update server 9 only when information output is permitted (step S6).

It is desirable that this information output permission information is generated based on a decision by the user 4 when, for example, the user 4 applies for an Internet connection service, and can be updated anytime based on a decision by the user 4. Also, since a plurality of the users 4 who permit an information output form a population of the aforesaid access information, it is very important to study this population in order to analyze the user preference information.

Therefore, the aforesaid update server 9 stores, retains and updates this access information in a user collective information storage section 17 and, if necessary, outputs the access information to the aforesaid system for providing Internet user information 2.

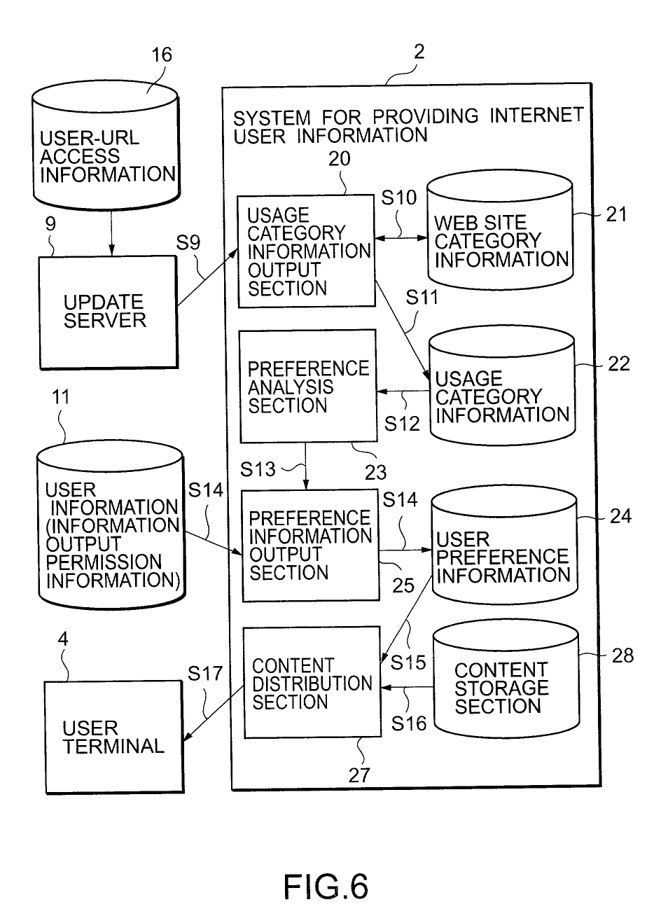

Next, this system for providing Internet user information 2 will be described in accordance with FIG. 6.

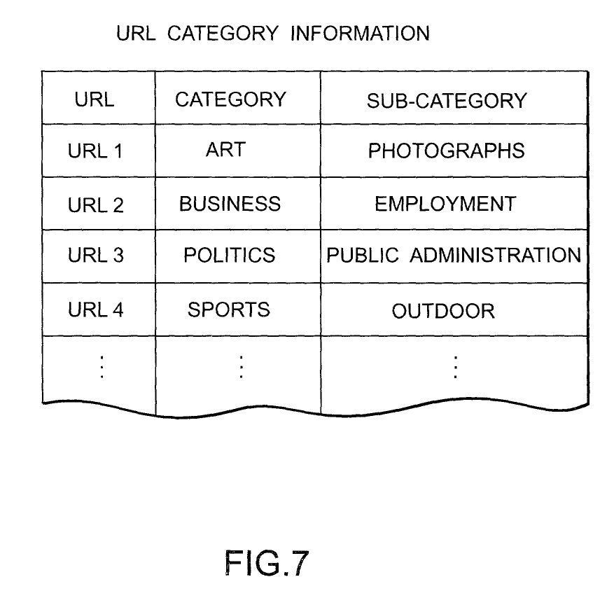

User-URL access information sent from the aforesaid update server 9 is obtained by a usage category information output section, shown as 20 in FIG. 6 (step S9). This usage category information output section 20 is connected to a category information storage section 21, which comprises category information (information of categorized various URL's; that is, information created by categorizing each URL using predetermined categories as shown in FIG. 7). The aforesaid usage category information output section 20 references a URL accessed by the user 4, stored in the received user-URL access information, and this category information (step S10) to thereby generates usage category information, indicating a category to which the URL belongs, and accumulates the usage category information in a usage category information storage section 22 (step S11). In this case, it is desirable that, for example, every time the user 4 accesses a URL, a point is added to a category corresponding to the URL.

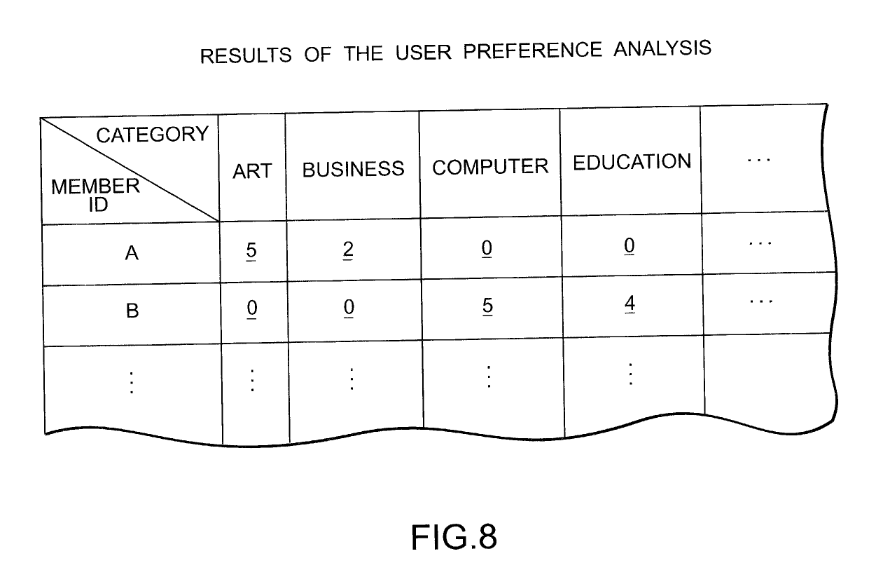

Next, in this system 2, a preference analysis section, shown as 23 in the drawing, extracts usage category information for each user from the aforesaid usage category information storage section (step S12), and analyzes the user preferences by, for example, statistical processing. As shown in FIG. 8, this analysis is performed by, for example, accumulating the aforesaid points for a predetermined period of time for categories in which each user was interested and determining a category ranking, and results of the analysis are output to a user preference information storage section 24 by a preference information output section 25 (step S13, S14). Incidentally, it is preferable that the point accumulation is performed for both a main category and a sub-category.

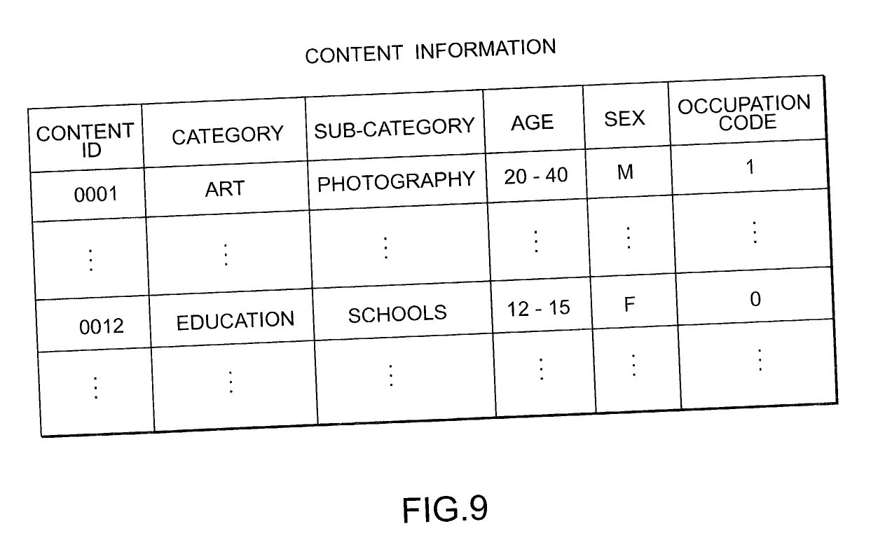

This user preference information can be applied to various purposes. In this embodiment, the user preference information is used for distribution of multimedia contents such as document files, sound files, image files and the like. In other words, this system 2 has a content distribution section 27, which is connected to a content storage section 28 for categorizing various contents into the aforesaid categories, and storing each content in association with a corresponding category as shown in FIG. 9.

Then, the content distribution section 27 is structured to obtain the user preference information for a predetermined user from the user preference information storage section 24 (step S15), extract contents which belong to, for example, a category in which the user 4 is most interested, and distribute the contents to the user 4 (step S16, step S17).

Here, content distribution by this content distribution section 27 can be executed every time information is sent from the aforesaid update server 9, or displayed when the user 4 connects to an Internet service provider which has the aforesaid system for Internet connections 1.

Also, it is desirable that various contents stored in the content storage section 28 are associated with not only categories but also preferable sex, age group, and occupation of the user. Thereby, the aforesaid content distribution section 27 can select contents to distribute based on not only preference information but also user attributes stored in the user information storage section 11.

According to such a structure, the following effects can be obtained.

First, according to the aforesaid embodiment, it is possible to generate dynamic preference information based on the latest behavior of the user 4 instead of relying on static preference information entered when the user 4 applied for the Internet service. Therefore, it is possible to distribute contents which always match needs of the user 4. Moreover, in this case, there is an effect that the user 4 can automatically update his/her preference information without needing to perform onerous update procedures for his/her preference information by himself/herself.

Secondly, according to the aforesaid embodiment, the URL access log for each IP address is obtained by the substitute server 8 provided between the user 4 and the Internet, and URL accessed by the user 4 is determined with this IP address. Therefore, there is an effect that the user preferences can be infallibly obtained with a simple structure by establishing an Internet connection through a predetermined server (site).

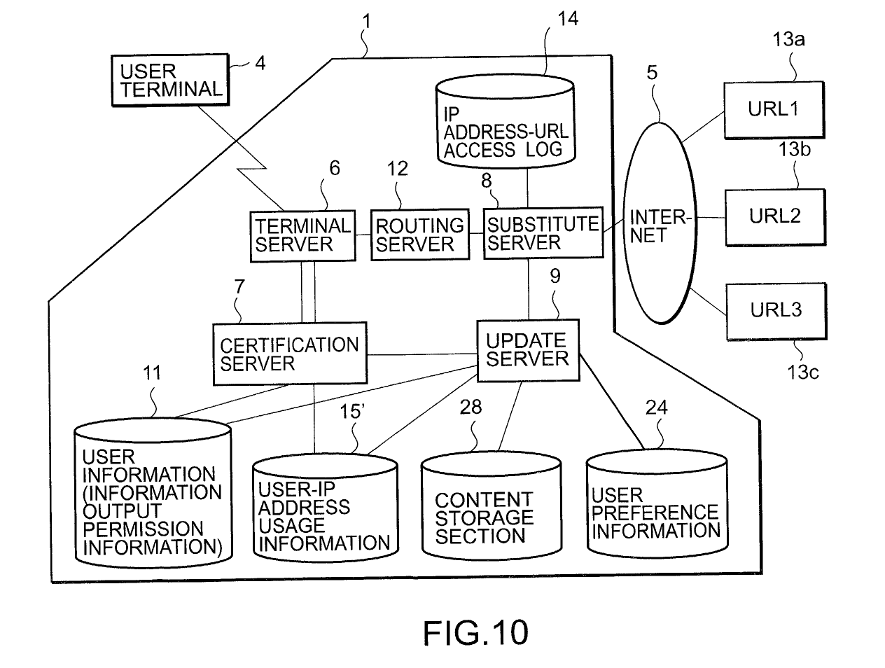

Incidentally, in the aforesaid first embodiment, information stored in the user-IP address usage information 15 is not limited to information on connection time by the IP address. For example, such information on connection time is not necessary if digital contents are distributed in real time to users who are connected with the Internet at the time of the distribution according to preferences of each user. A system structure in a case described above is shown in FIG. 10.

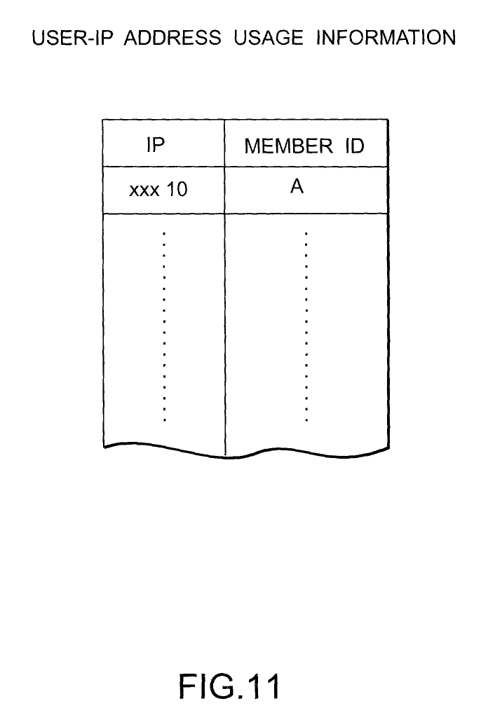

As shown in FIG. 11, user-IP address usage information 15′ includes an IP address and an ID of a user who is currently using the IP address. This usage information is generated by assigning a user ID to one of a plurality of predetermined IP addresses when the aforesaid certification server 7 performs certification for the user 4. Then, the user ID is erased and an association between the user ID and the IP address is terminated when the user is disconnected from the Internet.

The aforesaid update server 9 obtains preference information of the user from the user preference information storage section 24 based on the user ID in this IP address usage information storage section 15′, extracts contents corresponding to the preference information from the aforesaid content storage section 28 and distributes the contents to the user 4 in real time.

More specifically, a frame function of a browser can be used, for example, so that one of a plurality of frames is connected to the aforesaid update server 9, and displays the aforesaid digital contents in itself in a form of an advertisement, a link and the like.

According to such a structure, an advertisement effect can be reinforced since the user 4 can display contents according to his/her preferences during an Internet connection in real time.

In the aforesaid first embodiment, information stored in the user-URL access information storage section 16 is designed to be output to the aforesaid system for providing Internet user information 2. However, this information can also be output as the user access history information with links to each URL accessed based on a request from the user 4. According to a structure described above, even in an environment where one user uses a plurality of different terminals or browsers, it is possible to present unified access history information of the user.

Also, it is possible to directly provide an advertisement agency and the like with, for example, the user-URL access information. In this case, if the aforesaid system for providing Internet user information 2 is provided at this advertisement agency, it is possible to place/distribute an advertisement toward an Internet user according to individual needs of the Internet user using means such as electronic mail and the like.

Furthermore, although the aforesaid first embodiment was described based on an example of a dial-up connection, it is possible to apply this first embodiment to a full-time connection and the like.

Moreover, in the aforesaid first embodiment, an output of the user-URL access information and an analysis and the like of the user preference information are performed each time an update command is issued from the aforesaid certification server. However, the output and analysis can be performed in other times such as during an evening with batch processing and the like.

Also, in the aforesaid first embodiment, an output of URL access information to the aforesaid Internet user information system 2 is performed based on a decision by the user (information output permission information). However, this output can be performed for URL access information for all users under predetermined conditions. Also, as for population information, an output can be performed not only for the collective user information of the users who permit an output of the access information, but also for collective user information of the users who do not permit an output of the access information.

(Second Embodiment)

Next, a second embodiment of the present invention will be described.

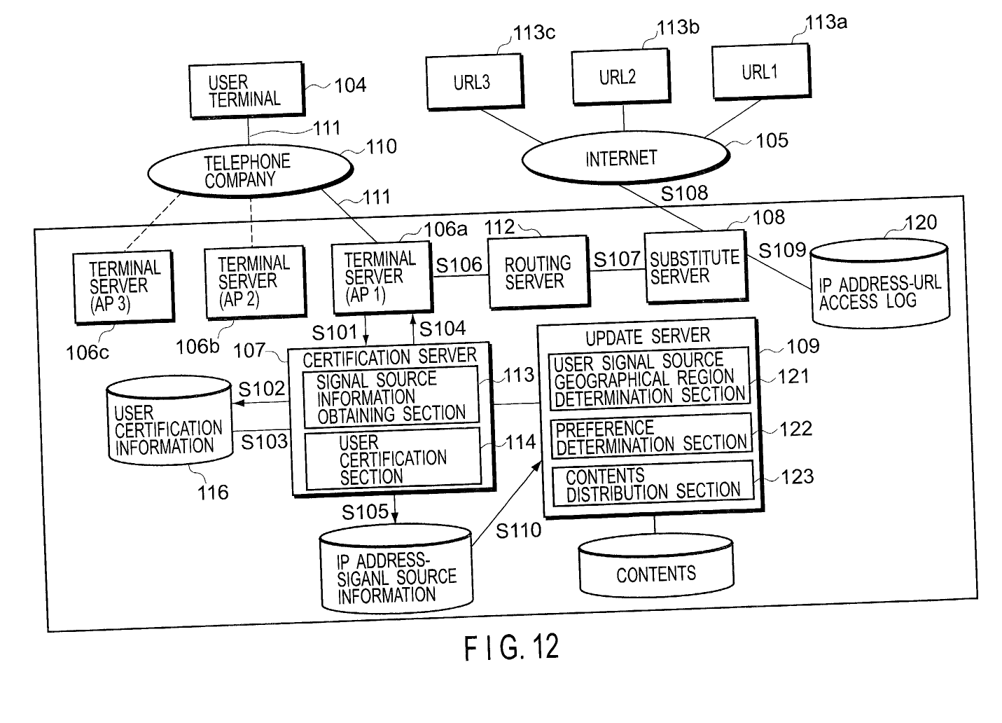

In the aforesaid first embodiment, a URL accessed by the user is determined and contents are distributed based on the URL. In the second embodiment, contents are distributed based on signal source information (a signal source telephone number) of the user in addition to the URL accessed by the user. This second embodiment will be described below in accordance with FIG. 12-FIG. 20.

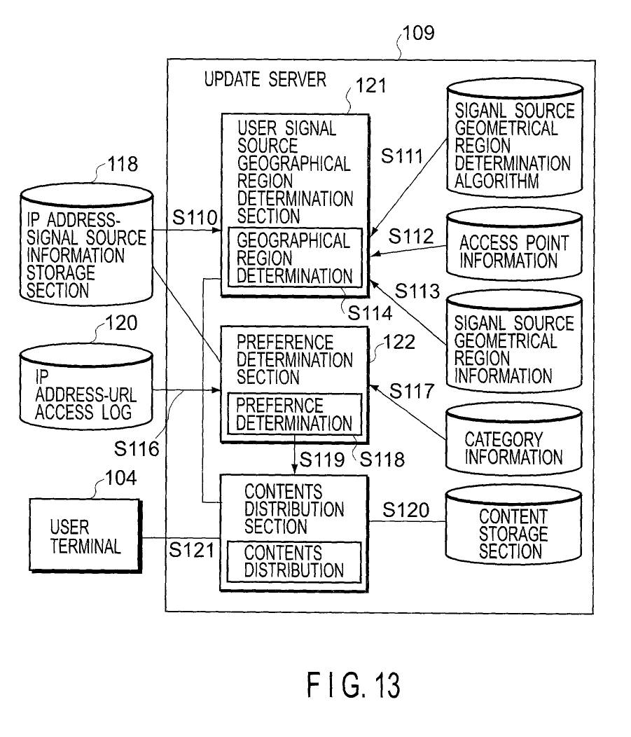

FIG. 12 and FIG. 13 are function block diagrams showing a system for Internet connections 101 provided at an Internet service provider and the like according to the second embodiment of the present invention. Incidentally, S101-S122 in each drawing are step reference numbers used to describe procedures in this system for Internet connections 101.

As shown in FIG. 12, the aforesaid system for Internet connections 101 comprises terminal servers 106a-106c for assigning an IP address to a user 104 (a user terminal) who performed a dial-up connection from a telephone line inside or outside of the user's home, and connecting the user 104 to the Internet 5, a certification server 107 for performing certification of the user as well as obtaining signal source information of the user 104, who connected to the aforesaid terminal servers 106a-106c, a substitute server 108, which is designed to exist in the connection route between the user 104 and the Internet, for obtaining a URL access log for an IP address used for the user's Internet connection, and an update server 109 for calculating a signal source geometrical region and access information for each user 104 from the aforesaid signal source information and the aforesaid URL access log, and distributing contents according to the user preferences based on the signal source geometrical region and access information.

The structure and functions of this system 101 will be described below based on the operation of the system 101.

(Terminal Servers)

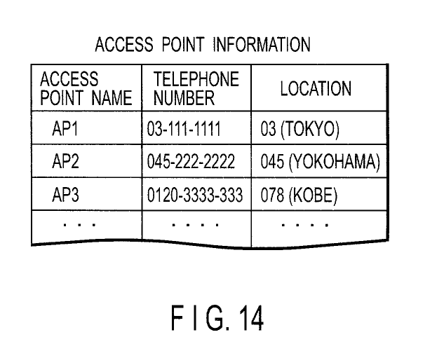

First, each of the aforesaid terminal servers 106a-106c has a plurality of ports (not illustrated), to which communication modems are connected, and is designed to be connected with the user 104 through, for example, a public circuit 111 connected to a telephone company switchboard 110. Each of the terminal servers 106a-106c is provided at access point AP1 (Tokyo), access point AP2 (Yokohama) and access point AP3 (Kobe) shown in FIG. 14. A telephone number for collect calls (0120-, 1-800-, 1-877- or the like) may be assigned to these access points just as at the access point AP3.

Also, these terminal servers 106a-106c have a function for receiving a user ID and a password as certification information as well as obtaining the signal source information (the signal source telephone number and the like) for the user 104 based on an incoming signal from the telephone company 110 when connecting a call from the user 104. If a connection with the user 104 is established, these terminal servers 106a-106c pass the aforesaid signal source information and certification information to the aforesaid certification server 107 to thereby issue a certification command (step S101).

Incidentally, for example, if a collect call telephone number is assigned just as at the access point AP3, the aforesaid terminal server 106c preferably refuses a line connection itself if the signal source information of the user is not included in the incoming signal from the telephone company. Thus, the Internet service provider can avoid unnecessary charges.

(Certification Server)

As shown in FIG. 12, the aforesaid certification server 107, comprises a signal source information obtaining section 113 for obtaining the signal source information received from the aforesaid terminal servers 106a-106c and a user certification section 114 for receiving the certification information of the user and performing the certification.

The signal source information obtaining section 113 has a function for obtaining the signal source telephone number if a signal source telephone number can be obtained as the signal source information, or a line network type (public telephone, cellular telephone or the like) if the signal source telephone number cannot be obtained.

The user certification section 114 is connected to a user certification information storage section 116, which stores the user information including the user ID and password therein. Also, this user certification section 114 has a function for comparing the certification information entered by the user 104 with the user information stored in the user certification information storage section 116 to thereby perform the certification for the user 104 (step S102, S103).

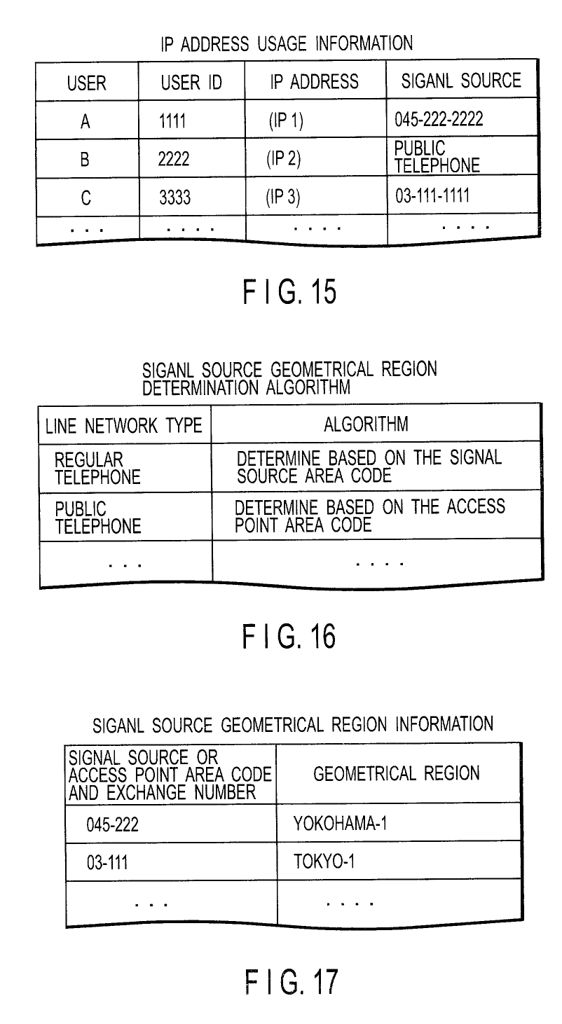

Based on a result of this certification, the aforesaid certification server 107 returns an affirmative or negative certification result to the aforesaid terminal servers 106a-106c (step S104). Then, based on the result, this certification server 107 stores the user's ID, an IP address assigned to this user and the signal source information as shown in FIG. 15 in an IP address-signal source information storage section, shown as 118 in FIG. 13 (step S5).

Concomitantly, the aforesaid terminal server 106 permits an Internet connection for the user 104 based on an affirmative certification result from the certification server 107 and assigns the aforesaid IP address to a port to which the user 104 is connected. Thus, the user 104 can download information from/upload information to various URL's (Web sites) using this IP address until the user 104 disconnects the connection from the terminal servers 106a-106c (step S106).

(Routing Server and Substitute Server)

As shown in FIG. 12, the aforesaid terminal server 106 is connected to a routing server 112 (router). This routing server 112 is designed to route so that all connections to the Internet through the terminal server 106 are via the aforesaid substitute server 108 (step S107).

For example, if the user 104 issues a browsing request for a URL 1, shown as 113a in FIG. 12, an access to this URL 1 will be routed through the aforesaid substitute server 108 (steps S106, S107 and S108). Thus, the substitute server 108 obtains an access log, which indicates both IP addresses and URL's for which the IP addresses issued a connection request, and stores the access log in an IP address-URL access log storage section 120 (step S109). Each time the user 104 issues a connection request for a URL (URL 2, URL 3 or the like), the aforesaid substitute server 108 records a corresponding information in the access log.

(Update Server)

As shown in FIG. 12, the aforesaid update server 109 comprises, a user signal source geographical region determination section 121 for determining a signal source geographical region for the user based on the user signal source information, a preference determination section 122 for determining the user preferences based on the aforesaid URL access log for the user, and a contents distribution section 123 for distributing contents according to the signal source geographical region and the user preferences based on the determination results from the user signal source geographical region determination section 121 and the preference determination section 122.

Functions of this update server 109 will be described in detail below in accordance with FIG. 13.

First, the user signal source geographical region determination section 121 is activated based on an update command, which is regularly generated with a predetermined update cycle (several minutes or several seconds), and retrieves the signal source information of the user from the aforesaid IP address-signal source information storage section 118 (step S110).

This user signal source geographical region determination section 121 is connected to a signal source determination algorithm storage section 125 for storing an algorithm to determine a signal source, an access point information storage section 127 for storing geometrical region information for a location of the aforesaid access point, and a signal source geographical region information storage section 126 for determining the signal source geographical region from the aforesaid signal source information.

As shown in FIG. 16, an algorithm storage section 128 stores therein a line network type used by the user in association with a signal source determination algorithm for the line network type. For example, if the line network type is cellular telephone, regular telephone line or the like, the signal source geographical region is determined based on the signal source telephone number (area code and exchange number). Also, if the signal source telephone number is unknown for the line network type such as PHS, public telephone or the like, the signal source geographical region is determined based on the area code and exchange number of a geometrical region of the access point location (step S111).

Since an access point name, a contract telephone number of the access point and the area code and exchange number of the access point are stored in the access point information storage section 127 as shown in FIG. 14, the area code and exchange number of the access point can be retrieved from this access point storage section 127 if this access point can be identified (step S112).

As shown in FIG. 17, the aforesaid signal source geographical region information storage section 126 stores therein the telephone number of the signal source in association with the signal source geometrical region (or a geometrical region code of a zip code and the like). Therefore, this user signal source geographical region determination section 121 applies the area code and exchange number of this signal source telephone number if the user signal source telephone number is known, or otherwise applies the area code and exchange number of the access point to thereby determine the signal source geographical region for the user 104 (step S114), and outputs this result to the aforesaid contents distribution section 123 (step S115).

Concomitantly, the aforesaid preference determination section 122 retrieves a URL access log for this IP address from the aforesaid IP address-URL access log storage section 120 every predetermined update cycle while this IP address is in use (step S116).

This preference determination section 122 is connected to a category information storage section 129 for storing category information for various URL's, i.e., information created by categorizing URL's into predetermined genres. This preference determination section 122 applies a URL accessed by each user, which is retrieved from the aforesaid IP address-signal source information storage section 118, to this category information to thereby determine a category to which the URL accessed by the user 104 belongs (step S117, S118).

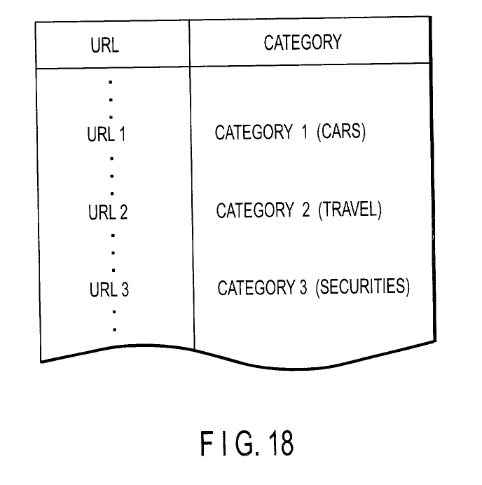

FIG. 18 is one example of the category information. For example, the aforesaid URL 1 is categorized into “Cars” category, URL 2 “Travel” category, and URL 3 “Securities” category.

A determination result by this preference determination section 122 is also output to the aforesaid content distribution section 123 (step S119).

Next, the aforesaid content distribution section 123 will be described.

The signal source geometrical region information and the category information on the accessed URL for each of the user 104, which are output from the aforesaid signal source geographical region information determination section 121 and the aforesaid preference determination section 122, respectively, will become source data for distributing contents according to the user preferences. This contents distribution section 123 is connected to a contents storage section 130 for storing various multimedia digital contents such as document files, sound files, image files and the like in association with the aforesaid signal source geographical region information and category information. Here, the primary usage of the contents is for advertising.

This contents distribution section 123 retrieves contents related to the signal source geographical region the user 104 and contents which belongs to a category in which the user is most interested from the aforesaid contents storage section 130 (step S120), and generates an HTML document for accessing these contents (contents generation). The aforesaid contents may be directly displayed in the HTML document or embedded as links. This contents distribution section 123 controls the aforesaid routing server 112 to thereby display this HTML document on a terminal of the user 104 separately from a URL home page and the like being accessed by the user 104 by utilizing a browser frame function and the like (step S121).

Thus, the user can brows an advertisement, information and the like related to the signal source geographical region from which the user is currently connecting to the Internet, contents related to the URL which the user is currently accessing, and the like in real time.

(Software for Internet Connections)

In the aforesaid second embodiment, the signal source information must be obtained at the time of the user's dial-up connection with the Internet. In the current system, for regular telephone lines, it is required to add a predetermined code to a connection target telephone number at the time of the dial-up connection.

For this reason, it is preferable in this embodiment to distribute to the user software for Internet connections to be installed in the user's computer system by the user.

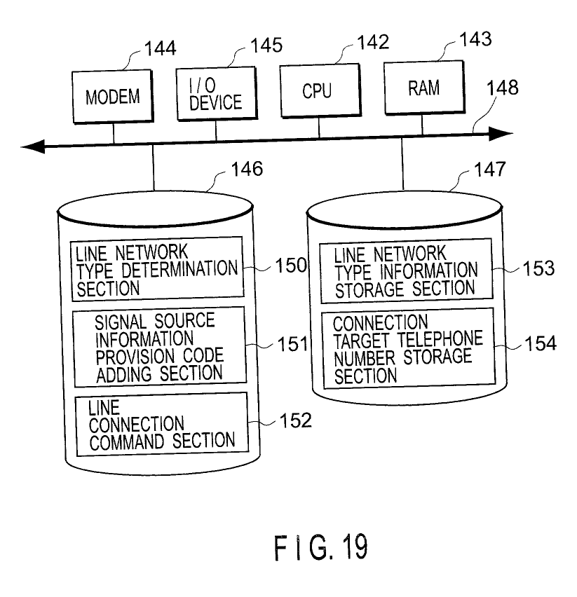

FIG. 19 is a schematic structural view showing a computer system where this program is installed.

In this system, a program storage section 146 and a data storage section 147 are connected to a bus 148, to which an I/O device 145 and the like are connected such as a CPU 142, a RAM 143, a modem 144, a monitor, a keyboard and the like. The program storage section 146 and the data storage section 147 may actually consist of an identical storage media, or of different storage media.

The program storage section 146 has, among others unrelated to this embodiment and besides a main program not illustrated, a line network type determination section 150 for determining a utilized line network type, a signal source information provision code adding section 151 for adding a signal source information provision code to the connection target telephone number if the line network type is a predetermined line network type, and a line connection command section 152 for performing a connection to the aforesaid connection target telephone number through the aforesaid modem 144.

Also, the data storage section 147 is connected to a line network type information storage section 153 for storing the line network type, which is used for the connection from the user terminal to the access point, as well as the signal source information provision code information, and a connection target telephone number storage section 154 for storing the connection target telephone number for each access point.

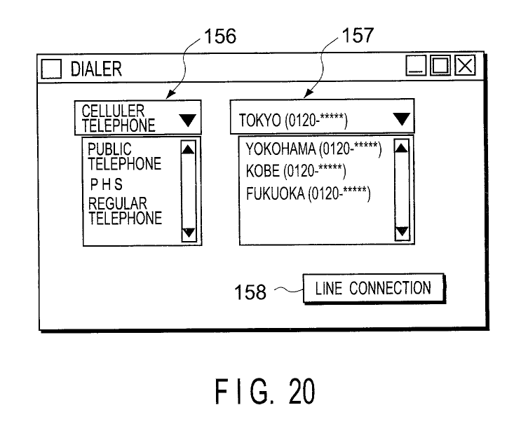

When this program is activated, the aforesaid main program displays an image such as the one in FIG. 20 on the monitor screen (I/O device 145) first. This image consists of a line network selection section 156 and a connection target telephone number selection section 157. The aforesaid line connection command section 152 is structured to perform a connection in a signal source information notification mode if the user selects an appropriate parameter and pushes a line connection button 158.

(Effects of the Second Embodiment)

According to such a structure, the following effects are obtained.

First, according to the aforesaid embodiment, it is possible to always provide contents distribution and the like suited for needs of the user 104 since this embodiment does not depend on static preference information entered at the time of a service application by the user, but rather generates dynamic preference information based on the latest behavior of the user 104. Especially, when the user connects with the Internet from a location different from where he/she applied for the service, for example, his/her business trip destination, it is possible to provide contents related to this destination.

Second, according to the aforesaid embodiment, the user signal source geographical region can always be determined since an information code, required for notification of the signal source telephone number, is always added according to the line network type by enforcing a use of proprietary software for Internet connections. Also, if the incoming signal from the telephone company cannot include the signal source information, it is possible to distribute contents related to the geometrical region of the access point.

Thirdly, according to the aforesaid embodiment, a URL access log for each IP address is obtained and a URL accessed by the user 104 is determined using this IP address by providing the substitute server 108 and routing the user's Internet connection through this substitute server 108. By routing the Internet connection through a specific server (site) as described above, the user preferences can always be obtained with a simple structure.

Incidentally, although the system of the aforesaid second embodiment is designed to distribute the aforesaid contents to the user terminal in real time, contents such as an advertisement and the like may be distributed later with means such as electronic mail and the like. In this case, the user signal source geographical region determination section 121, the preference determination section 122 and contents distribution section 123, provided in the aforesaid update server 109, do not necessarily need to be provided at the Internet service provider. They can also be provided in an information provision system at an information provider.

Also, a party to distribute contents such as an advertisement and the like to the user may be a Web site which the user accesses. In this case, it is preferable that the Web site indicates the IP address of the user to this system for Internet connections, and receives the user signal source geographical region and the user preference information. Thus, the Web site can present an advertisement and the like suited for the user signal source geographical region and the user preference information to the user who accesses the Web site. Preferably, a presentation of this advertisement and the like is performed using a browser frame function.

Also, the aforesaid system may be designed to output connection historical information of the user, which includes a link to each URL accessed, in response to a user request. According to such a structure, it is possible to present a unified connection historical information to a user even when the user uses a plurality of different terminals or browsers.

Moreover, the aforesaid second embodiment is applied to dial-up connections, it can be applied to dedicated line connections and the like.

Furthermore, in the aforesaid second embodiment, it is desirable that an output of the signal source information and the URL access information to the aforesaid update server 109 is performed based on the user's own decision (information output permission information). However, this output permission is not limited to the above condition and the signal source information and the URL access information may be output for all users under predetermined conditions.

Furthermore, in the aforesaid second embodiment, although the present invention is applied to a system for connecting the user terminal with the Internet, it is possible to distribute, for example, a program (digital contents), stored at a program distribution station for digital satellite broadcasting, using a ground wave according to the geometrical region of the user signal source.

Further, the present invention is not limited to the aforesaid embodiments, and various changes and modifications can be made, without departing from the scope and spirit of the present invention.

What is claimed is:

1. A system for Internet connections, which connects a user to a network, comprising:
an IP address usage information storage means for storing usage information regarding an IP address in association with the user using the IP address;
an access log recording means for recording an access log for a Web site in association with a IP address; and
an access information output means for referencing the usage information regarding the IP address and the access log for the Web site, to thereby associate and output an address of the Web site and information of the user accessing this Web site.

2. A system as set forth in claim 1,
wherein said access log recording means is provided in a substitute server, through which the user terminal connects with the Internet.

3. A system as set forth in claim 1, further comprising:
means for storing and identifying information on user permission to output access information,
wherein said access information output means outputs the access information if the user permits an output of the access information.

4. A system as set forth in claim 3, further comprising:
means for providing access information and collective user information for users who permit an output of said access information.

5. A system as set forth in claim 1, further comprising:
a certification means for performing user certification,
wherein said IP address usage information storage means associates and stores user information obtained by this certification means and the IP address usage information.

6. A system as set forth in claim 1, further comprising:
means for categorizing and storing information on various Web sites; and
means for referencing said access information from said access information output means and category information to thereby associate and output a category of a Web site accessed and information of the user who accesses this Web site.

7. A system as set forth in claim 6, comprising:
means for accumulating usage category information of the user to thereby analyze user preferences; and
means for outputting preference information in association with the user ID.

8. A system as set forth in claim 7, further comprising:
a content storage means for storing various contents in association with the category; and
means for extracting contents from said content storage means and distributing the contents to the user based on the preference information of the user.

9. A system for providing Internet user information, comprising:
means for storing the user information in association with Web site access information of the user;
means for categorizing and storing information on various Web sites; and
means for referencing said access information and the category information to thereby associate and output the category of the Web site accessed and information of the user who accesses this Web site.

10. A system as set forth in claim 9, further comprising:
means for accumulating usage category information of the user to thereby analyze the user preferences; and
means for outputting the preference information in association with the user ID.

11. A system as set forth in claim 10, further comprising:
a content storage means for storing various contents in association with the category; and
means for extracting contents from said content storage means and distributing the contents to the user based on the preference information of the user.

12. A system for Internet connections, which connects a user terminal to a network, comprising:
an IP address usage information storage means for storing usage information regarding an IP address in association with a user ID, the user ID using the IP address;
a content storage means for storing contents corresponding to the user preferences in association with the user ID; and
means for extracting contents corresponding to the user preferences from said content storage means and displaying the contents on the user terminal using the IP address.

13. A method for providing Internet user preference information,
wherein an Internet service provider system obtains a Web site access log for a user of the Internet connection service; and
the Internet service provider system generates and provides preference information of the user based on this Web site access log.

14. A method for distributing digital contents using the Internet, comprising the steps of:
(a) receiving Web site access information of a user of the Internet connection service from the Internet service provider system to thereby generate preference information of the user; and
(b) distributing digital contents corresponding to the preference information to the user.

15. A system for Internet connections, which connects a user terminal to the network, comprising:
a terminal server for assigning a predetermined IP address to the user terminal and connecting this user terminal to a request Web site through an Internet network;
a certification server for outputting IP address usage information of the user as well as performing a certification for the user who accesses said terminal server;
a substitute server, through which the Internet connection is routed when the user terminal is connected to said request Web site in order to record/output an access log for the Web site accessed by said IP address; and
an update server for referencing the access log, recorded/output by the substitute server, and said IP address usage information, output by said certification server, to thereby output the Web site in association with the user who accesses this Web site.

16. A system for Internet connections, which connects a user terminal to the network, comprising:
means for obtaining user signal source geographical region information;
a content generation means for generating contents according to a signal source geographical region; and
a content distribution means for distributing the contents generated by said content generation means to the user terminal connected to the Internet.

17. A system for Internet connections as set forth in claim 16,
wherein said means for obtaining user signal source geographical region information comprises:
means for obtaining signal source information of the user, which is included in an incoming signal from a telephone company; and
a signal source geographical region determination means for determining the signal source geographical region based on this telephone number if said signal source information contains a signal source telephone number.

18. A system for Internet connections as set forth in claim 17,
wherein said signal source geographical region determination means determines a geometrical region of an access point which is accessed by the user as the signal source geographical region if the signal source information does not include the signal source telephone number of the user.

19. A system for Internet connections as set forth in claim 16,
wherein said content distribution means distributes said contents to the user by routing a connection of the user to a site which includes said contents.

20. A system for Internet connections as set forth in claim 16, further comprising:
means for storing IP address usage information in association with the user of this IP address; and
an access log recording means for recording an access log of a Web site accessed by the user using an IP address used for the Internet connection;
wherein said content distribution means comprises means for comparing the IP address in log information recorded by the access log recording means and said IP address usage information to thereby determine a Web site accessed by the user and distribute contents related to this Web site to the user terminal.

21. A system for Internet connections as set forth in claim 20,
wherein said access log recording means is provided in a substitute server, through which the user terminal is connected to the Internet.

22. A system for Internet connections as set forth in claim 20,
wherein said content distribution means
comprises means for storing categorized information on various Web sites, and
determines a category to which the Web site, accessed by the user, belongs and distributes contents related to the category to the user.

23. A system for distributing contents to the user terminal, comprising:
means for obtaining user signal source geographical region information;
a content generation means for generating contents according to the signal source geographical region for the user; and
a content distribution means for distributing the contents, generated by said content generation means, to the user terminal.

24. A system for Internet connections, which connects a user terminal to a network, comprising:
means for obtaining signal source information of the user from the telephone company;
a signal source geographical region determination means for determining the signal source geographical region for the user with this signal source information; and
a user signal source geographical information output means for outputting the signal source geographical region, the signal source geographical region determined by this signal source geographical region determination means, in association with the user.

25. A system for Internet connections as set forth in claim 24,
wherein the user signal source geographical information output means outputs the user signal source geographical information in response to an output request, the output request being from the Web site accessed by the user, for the user signal source geographical information which indicates the IP address of the user.

26. A system for Internet connections, which connects a user terminal to a network, comprising:
means for assigning an IP address to the user terminal and connecting the user terminal to the Internet;
means for storing user information in association with the user; and
means for outputting the user information to a Web site accessed by the user in response to an output request from the Web site for the user information which indicates the IP address of the user.

27. A system for distributing contents to the user terminal through the Internet, comprising:
means for obtaining user signal source geographical region information;
a content generation means for generating contents according to the signal source geographical region for the user; and
a content distribution means for distributing to the user terminal the contents, generated by said content generation means according to said signal source geometrical region.

28. A method for providing information to an Internet user,
wherein an Internet service provider determines the signal source geographical region for a user of its Internet connection service, generates contents related to this signal source geographical region and provides the contents to the user.

29. An Internet connection program product for issuing a command to a computer system to establish a dial-up connection with a predetermined Internet connection access point, comprising:
storage media;
means stored in this storage media for determining a line network type used; and
means stored in said storage media for adding a signal source information provision code to a telephone number used for an Internet connection if a line network type being used is a predetermined line network type.
